(19) United States
(12) Patent Application Publication
(10) Pub. No.: US 2022/0168681 A1
(43) Pub. Date: Jun. 2, 2022

(54) FACE MASK WITH ELECTRICALLY ACTIVE COVID-19 FILTERATION

(71) Applicants: Dawood Mahmood, Royal Palm Beach, FL (US); Muzammil A. Patel, Royal Palm Beach, FL (US)

(72) Inventors: Dawood Mahmood, Royal Palm Beach, FL (US); Muzammil A. Patel, Royal Palm Beach, FL (US)

(21) Appl. No.: 17/449,950

(22) Filed: Oct. 5, 2021

Related U.S. Application Data
(60) Provisional application No. 63/087,629, filed on Oct. 5, 2020.

(51) Int. Cl. B01D 46/00; A62B 18/02; A41D 13/11

(52) U.S. Cl. CPC B01D 46/0032; A41D 13/11; A62B 18/025

(57) ABSTRACT

An electrically live face mask device with rear face as the user facing end where the clean air is inhaled by user after the positively charged COVID-19 viral load has been filtered out by use of front filter, the positive metal mesh filter, the electrostatic filter, the negative metal mesh filter and the rear face mask filter. This electrically live COVID-19 filtration mask utilizes the fact that electrically positive COVID-19 can be trapped better in a positive and negative charged capacitor and always charged electrostatic filtration layer as compared to passive filtration from a regular face mask where the size of pours of the mask filter and its decreasing electrostatic charge due to environmental and human breath humidity are the only deterrent for COVID-19 viral load filtration.

This submission is linked with:

Provisional Application Number 63/087,629 Filed on Oct. 5, 2020

Confirmation Number 7627

EFS ID 40762495

### GENERAL CLASSIFICATION

This face mask is classified under both classes A41D 13/11 and A62B 23/025.

### FIELD

The present application relates to a face mask which incorporates two metallic fine mesh filters connected to a live battery and separated by an electrostatic filter thus repelling and trapping COVID-19 virus load within the face mask.

### SPECIFICATION

1—Recent scientific research regarding the process of binding of receptor-binding domain (RBD) of the SARS-CoV-2 spike protein (positively charged) to the human cell receptor ACE2 (negatively charged) which is required for viral entry into human cells. Many studies have been conducted to target the structures of RBD-ACE2 binding and to design RBD-targeting vaccines and drugs.

2—Based on these facts this face mask is designed to have a positively charged fine mesh filter on the outer side of face mask from where infected air enter the mask and thus repelling the positively charged viral load away. And even if due to inhalation negative pressure any positively charged virus still pass through the outside mask filter, the positive metal mesh, the electrostatic filter, it then has to pass through a negatively charged second metal mesh filter which will either attract it or will neutralize its positive charge and will trap the left over viral load from passing through the second mask filter layer thus providing virus elimination from inhaled air. Any leftover virus still being able to pass through the face mask will now be mostly neutral as charged and will find it very difficult to have a successful bond with human ACE2 receptors.

3—If a sick or non-symptomatic infected person wears this face mask then the inside of the mask filter layer and negatively charged mesh filter will attract and keep inside all of the emitting positive virus load and the electrostatic filter and positively charged outer mesh will further prevent any virus load to escape to outside air.

### BRIEF DESCRIPTION OF THE DRAWINGS

The six drawings which are part of the present description will be explained in further detail with reference to the example embodiments and described as below:

FIG. 1 is a front view of the electrically active face mask device.

FIG. 2 is a back view of the electrically active face mask device.

FIG. 3 is an elevation view of the electrically active face mask device.

FIG. 4 is a perspective view of the electrically active face mask device.

FIG. 5 is an elevation view of exploded cross section of the electrically active face mask device.

FIG. 6 is a perspective view of exploded cross section of the electrically active face mask device.

### DETAILED DESCRIPTION OF THE DRAWINGS

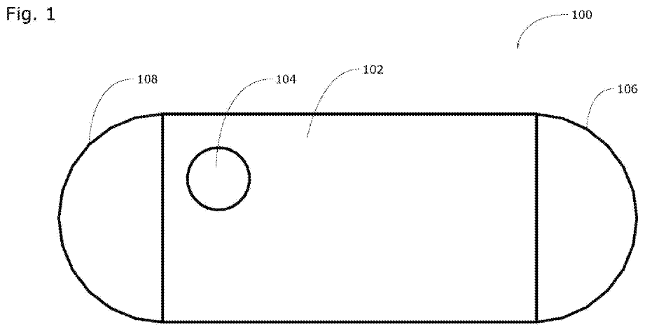

A first embodiment of the electrically active face mask is illustrated in FIG. 1 which shows the front view of the electrically active face mask 100 including front air filter as 102. There is a battery holder 104 attached to this mask which holds the battery to energize the metallic mesh filters. This embodiment also shows the elastic loops 106 and 108 for holding the mask in place by attaching to the user's left and right ears respectively.

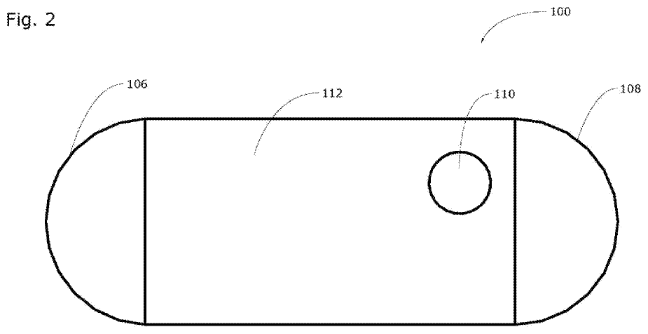

A second embodiment of the face mask is illustrated in FIG. 2 which shows the back view of the electrically active face mask 100 including rear air filter as 112. There is a cushioned sticker pad 110 which covers the battery holder terminals attached to this mask. This embodiment also shows the elastic loops 106 and 108 for holding the mask in place by attaching to the user's left and right ears respectively.

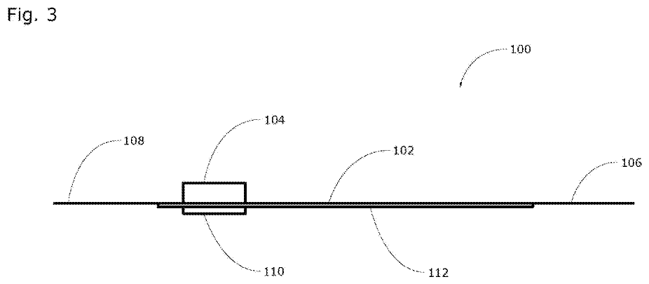

A third embodiment of the face mask is illustrated in FIG. 3 which shows the elevation view of the electrically active face mask 100 showing positioning of different components of the electrically active face mask including front air filter as 102 and rear air filter as 112. The battery holder 104 is shown on top and the cushioned sticker pad 110 is shown at the bottom. This embodiment also shows the elastic loops 106 and 108 for holding the mask in place by attaching to the user's left and right ears respectively.

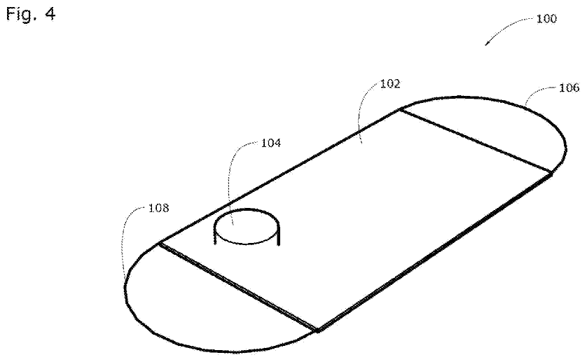

A fourth embodiment of the face mask is illustrated in FIG. 4 which shows the perspective view of the electrically active face mask 100 including front air filter as 102, the battery holder 104 which holds the battery to energize the metallic mesh filters. This embodiment also shows the elastic loops 106 and 108 for holding the mask in place by attaching to the user's left and right ears respectively.

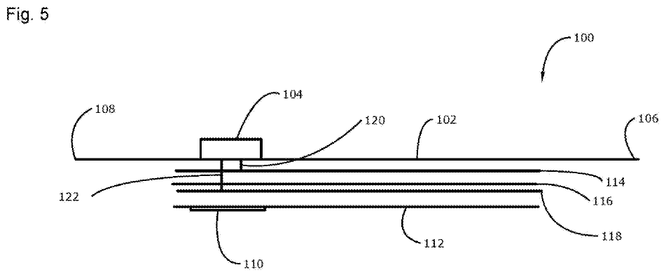

A fifth embodiment of the face mask is illustrated in FIG. 5 which shows the elevation view of exploded cross section of the electrically active face mask 100 showing positioning of different components of the electrically active face mask including front air filter as 102 and rear air filter as 112. The battery holder 104 is shown on top and the cushioned sticker pad 110 is shown at the bottom. This embodiment also shows the elastic loops 106 and 108 for holding the mask in place by attaching to the user's left and right ears respectively. The positive terminal 120 of the battery holder 104 is attached to second from top positive metallic mesh filter layer 114. The negative battery terminal 122 of battery holder 104 is attached to the negatively charged fourth metallic mesh layer 118 when counted from top to bottom. There is an electrostatic non-conductive third layer 116 when counted from top to bottom, which is sandwiched in between positive metallic mesh layer 114 and negative metallic mesh layer 118 forming a capacitor like configuration.

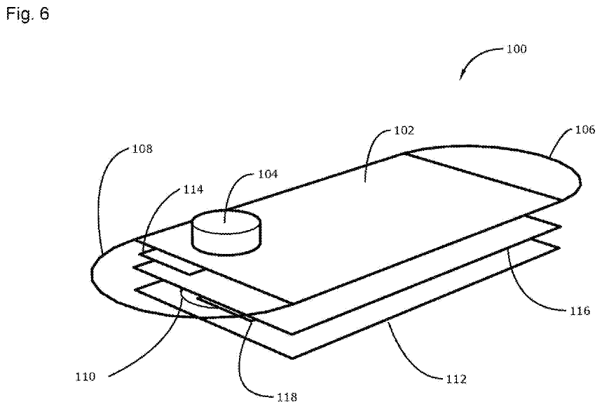

A sixth embodiment of the face mask is illustrated in FIG. 6 which shows the perspective view of exploded cross section of the electrically active face mask 100 showing positioning of different components of the electrically active face mask including front air filter as 102 and rear air filter as 112. The battery holder 104 is shown on top and the cushioned sticker pad 110 is shown at the bottom. This embodiment also shows the elastic loops 106 and 108 for holding the mask in place by attaching to the user's left and right ears respectively. The second from top positive metallic mesh filter layer 114 is shown in this embodiment with third electrostatic layer 116 and fourth layer from top as the negative metallic mesh layer 118.

When the user of this electrically active face mask inhales air in, the positively charged COVID-19 virus particles are first filtered by front filter layer 102. Most of the virus load which is air borne in tiny droplets is filtered out at this first front filter layer 102. The remaining individual virus load is now exposed to the positive metallic mesh layer 114 which repels out the positively charged virus as like charges repel each other. If any leftover virus load which is still pulled in due to vacuum of inhalation is now exposed to the highly electrostatic middle layer 116 which filters out virus from the inhaled air. Now if there is still any virus left in the inhaled air is now exposed to fourth metallic mesh layer 118 which provides two missing electrons to the positive COVID-19 virus and neutralize the virus while making it unable to connect to the ACE2 sites in human cells. The fifth and face facing filter layer 112 also captures any neutralized virus and make this mask as 99.72% efficient in filtering COVID-19 size 0.1 um particles as tested according to the filtration method described in ASTM F2299 standard.

1. An electrically active face mask with two ear loops in which electricity retains the electrostatic properties of center filtration layer.

2. A device according to claim 1 comprising of a pouch made of passive filtration material, wherein the front face is of a rectangular shape.

3. A device according to claim 2, wherein the front face has a first extent and a second extent and operational side is concavely extended out while in use.

4. A device according to claim 3, wherein the first extent is longer than the second extent and wherein the front face is convex when in use.

5. A device according to claim 4, wherein the front face and rear face join together to form a large pouch and a battery holder on the side of the longer extent.

6. A device according to claim 5, the battery holder with cover on the side of the longer extent and extending towards the smaller extent is holding the battery.

7. A device according to claim 6, the outer filter layers holds two fine mesh metallic filters separated by an electrostatic material.

8. A device according to claim 7, wherein the shape of the metal mesh filters is partial in size as to the device in shorter extent but extend to the full length on longer extents to connect to the battery holder terminals.

9. A device according to claim 7, wherein the material of the fine metal mesh filters is conductive metal.

10. A device according to claim 7, wherein the battery is connected to two metal mesh filters using terminals from the battery holder.

11. A device according to claim 10, wherein the positive mesh filter is towards the front side of the face mask and negative mesh filter is towards the facial side of the facial mask.

12. A device according to claim 11, wherein there is an electrostatic material in between the positive and negative metallic mesh filters to form a capacitor like configuration to repel from positive filter and attract COVID-19 positively charged viral load to the negatively charged metal mesh filter from inhaled air.
